(19) United States
(12) Patent Application Publication
(10) Pub. No.: US 2010/0207413 A1
(43) Pub. Date: Aug. 19, 2010

(54) CONNECTING PLATE AND A VAN-TYPE VEHICLE HAVING THE CONNECTING PLATE

(75) Inventors: T.H. HUANG, Qingdao City (CN); Robert WANG, Qingdao City (CN); Ryan XU, Qingdao City (CN); Tony LIANG, Qingdao City (CN)

Correspondence Address: CANTOR COLBURN, LLP, 20 Church Street, 22nd Floor, Hartford, CT, 06103, US

(73) Assignees: CHINA INTERNATIONAL MARINE CONTAINERS (GROUP) LTD., Guangdong (CN); QINGDAO CIMC REEFER TRAILER CO., LTD., Qingdao (CN); QINGDAO CIMC REEFER CONTAINER MANUFACTURE CO., LTD., Qingdao (CN); Qingdao CIMC Special Reefer Co., Ltd., Qingdao (CN)

(21) Appl. No.: 12/699,943

(22) Filed: Feb. 4, 2010

(30) Foreign Application Priority Data
Feb. 18, 2009 (CN) 200920009717.7

(51) Int. Cl. B62D 24/00

(52) U.S. Cl. 296/35.1

(57) ABSTRACT

The invention discloses a connecting plate and a van-type vehicle having the connecting plate. The connecting plate is used to connect the carriage and the frame of the van-type vehicle. The connecting plate has a generally gooseneck shape and comprises a wing plate coupling portion for coupling to a lower surface of an upper wing plate of a frame main longitudinal beam on exterior side, a fastener assembling portion for connecting to one end of the wing plate coupling portion, a carriage bottom coupling portion for coupling to a bottom surface of the carriage, and a connecting portion for a slant connection between the fastener assembling portion and the carriage bottom coupling portion. The fastener assembling portion has first through holes formed passing through from top to bottom therein. The carriage bottom coupling portion has second through holes formed passing through from top to bottom therein. A height difference between an upper surface of the wing plate coupling portion and the carriage bottom coupling portion is less than a thickness of the upper wing plate. Compared with the prior art, the invention has the advantages of simpler structure, greater strength, and easier production.

### FIELD OF THE INVENTION

The present invention relates to a van-type vehicle having a carriage and a frame which can be disassembled completely, and more specifically, a connecting structure between the frame and the carriage.

### BACKGROUND OF THE INVENTION

Generally, the van-type vehicle comprises two portions, a carriage and a frame.

The carriage may be a tank of a refrigerated or reefer or dry cargo van-type vehicle, a carriage of a van trailer, a carriage of a van semi trailer, and a tank of a refrigerated or reefer container, etc. A plurality of parallelly disposed bottom cross beams are provided in the bottom of the carriage.

Generally, the frame comprises at least two main longitudinal beams.

In a conventional van-type vehicle, the carriage and the frame are often connected by way of welding or passing-through beams and the like. FIG. 1 shows a mode of connecting the bottom cross beam 100 of the carriage with the main longitudinal beam 200 of the frame by welding. FIG. 2 shows a mode of connecting the bottom cross beam 10 of the carriage passing through the frame main longitudinal beam 20.

Both of the two modes above mentioned are to fasten a carriage and a frame together disassembly. Because of the structural limitation, it is impossible for the prior art to meet the requirements that the carriage and the frame (including a working assembly, an outrigger, a mud fender, an anti-collision frame and various accessories) are respectively manufactured in flow-line production and then assembled together; and the prior art cannot meet the requirements for export reefer or refrigerated vehicles that the carriage and the frame are respectively transported, and then assembled in another place.

### SUMMARY OF THE INVENTION

In view of the above problems with the prior art, the main purpose of the invention is to provide a connecting plate which can meet the requirement that a carriage and a frame of a van-type vehicle are respectively manufactured in flow-line production and then assembled together; or the requirement that export-products are respectively transported by sea and assembled in another place.

The other purpose of the invention is to provide a van-type vehicle including the connecting plate of the invention.

In order to achieve the above purpose of the invention, the invention provides a connecting plate for connecting a carriage and a frame of a van-type vehicle, wherein the connecting plate has a longitudinal section of a gooseneck shape and comprises a wing plate coupling portion for coupling to a lower surface of an upper wing plate of a frame main longitudinal beam on exterior side, a fastener assembling portion for connecting to one end of the wing plate coupling portion, a carriage bottom coupling portion for coupling to a bottom surface of the carriage, and a connecting portion for a slant connection between the fastener assembling portion and the carriage bottom coupling portion; first through holes are formed passing through from top to bottom in the fastener assembling portion; and second through holes are formed passing through from top to bottom in the carriage bottom coupling portion; a height difference between an upper surface of the wing plate coupling portion and the carriage bottom coupling portion is less than a thickness of the upper wing plate; and a thickness and a width of the connecting portion are gradually decreased from the fastener assembling portion to the carriage bottom coupling portion.

Preferably, a limit boss is formed between a side surface of the fastener assembling portion facing the wing plate coupling portion and the upper surface of the wing plate coupling portion.

Preferably, a plane outline of the connecting plate is a rectangle on one side and an isosceles trapezoid on the other side which extends from a longer edge of the rectangle to the other side.

Preferably, two first through holes arranged transversely along the connecting plate are formed in the fastener assembling portion; and two second through holes arranged transversely along the connecting plate are formed in the carriage bottom coupling portion.

Preferably, the connecting plate is forged integrally, has a structure of welded steel plates or a structure of bent steel plates.

In order to achieve the above purpose of the invention, the invention provides a van-type vehicle comprises a carriage and a frame, a plurality of bottom cross beams are disposed in the bottom of the carriage, and the frame comprises at least two main longitudinal beams, wherein the van-type vehicle further comprises at least two pairs of connecting plates symmetrically disposed along a longitudinal direction of the van-type vehicle of any one of claims 1-4; the wing plate coupling portion of the connecting plate is coupled to the lower surface of the upper wing plate of the frame longitudinal beam on exterior side; the carriage bottom coupling portion is coupled to the bottom surface of the carriage; nuts are pre-buried in the positions of the carriage corresponding to the first through holes and the second through holes of the connecting plate; and bolts are disposed passing through the first through holes as well as the nuts corresponding to the first through holes, bolts are disposed passing through the second through holes as well as the nuts corresponding to the second through holes.

Preferably, the nuts are pre-buried in the bottom cross beams of the carriage, and the carriage bottom coupling portion of the connecting plate is coupled to the lower surface of the bottom cross beam.

Preferably, the van-type vehicle comprises seven pairs of the connecting plates.

Compared with the prior art, the advantages and the beneficial effects of the invention are listed as follows:

1) the invention can simplify the structure, and facilitate the production;

2) the invention can facilitate flow-line production and assembly or export transportation and assembly;

3) the invention can provide higher strength, and more reliable connection.

### BRIEF DESCRIPTION OF DRAWINGS

FIG. 1 shows a connecting mode of welding between a carriage bottom cross beam and a frame main longitudinal beam in a conventional van-type vehicle;

FIG. 2 shows a connecting mode by which the frame main longitudinal beam passes through the carriage bottom cross beam in the conventional van-type vehicle;

FIG. 3 is a partial sectional view of a van-type vehicle according to the invention;

FIG. 4 is an enlarged view of the portion A in FIG. 3;

FIG. 5 is a partial sectional view as indicated by the arrow F in FIG. 3, where a lower wing plate of the main longitudinal beam is removed for facilitating observing the structure;

FIG. 6 is a diagram view of a connecting plate between the frame main longitudinal beam and the carriage bottom cross beam according to the invention (looking upwards form the bottom of the vehicle);

FIG. 7 is an enlarged view of B portion in FIG. 6.

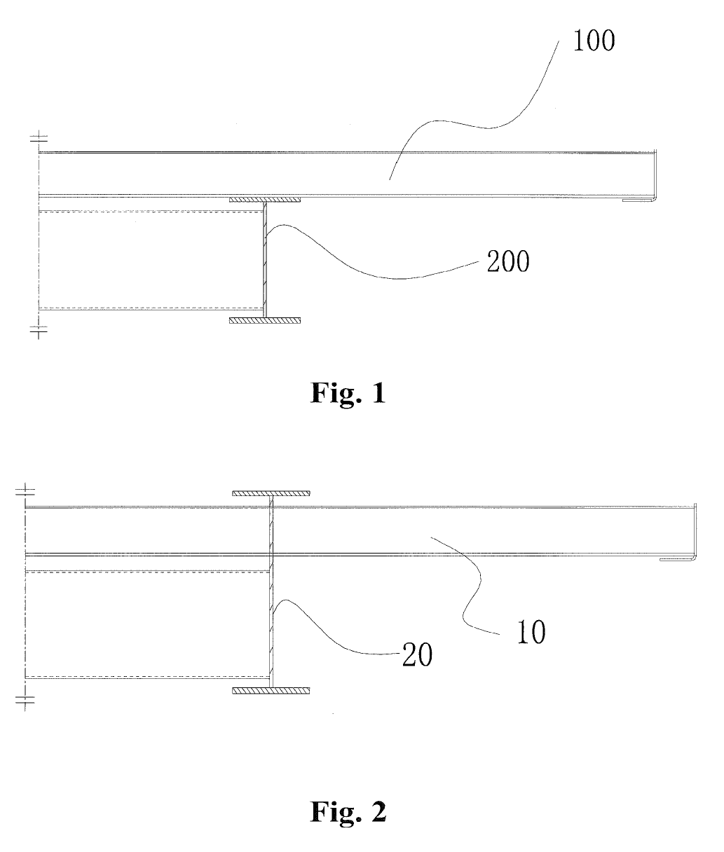

### DETAILED DESCRIPTION OF THE PREFERRED EMBODIMENTS

The invention will be further described with reference with drawings and the preferred embodiments hereinbelow.

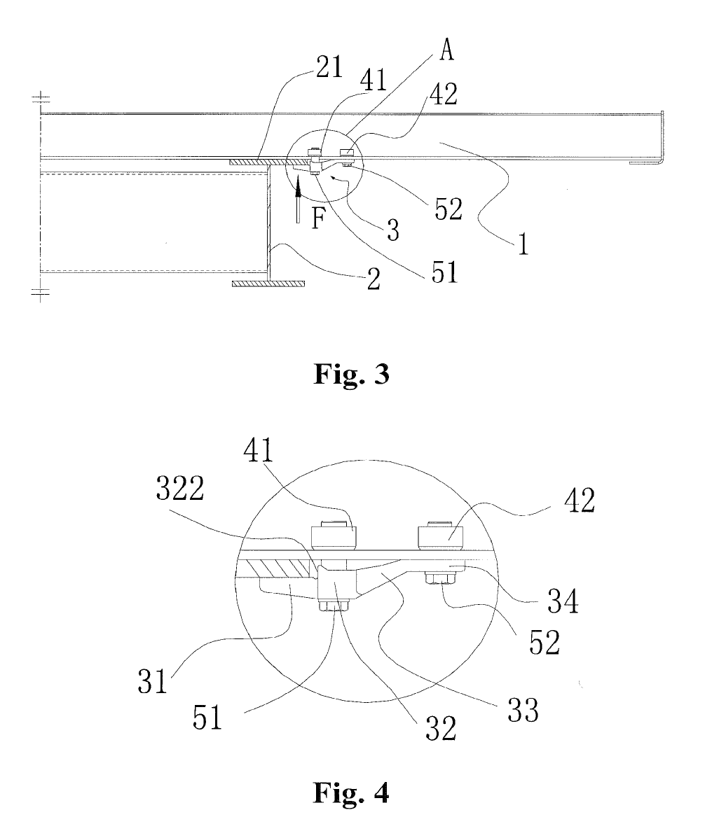

As shown in FIGS. 3-7, a van-type vehicle of the invention comprises a carriage and a frame. A plurality of bottom cross beams 1 in parallel are disposed in the bottom of the carriage. The frame comprises at least two main longitudinal beams 2. And at least two pairs of connecting plates 3 are symmetrically disposed along a longitudinal direction of the van-type vehicle of the invention.

As shown in FIG. 3, the main longitudinal beam 2 has a “ [symbol] ” structure and comprises an upper wing plate 21. The bottom cross beams 1 may have a square pipe structure or be a channel steel. Because the structures of the main longitudinal beams 2 and the bottom cross beams 1 are well-known for those skilled in the art, their further detailed description will be omitted.

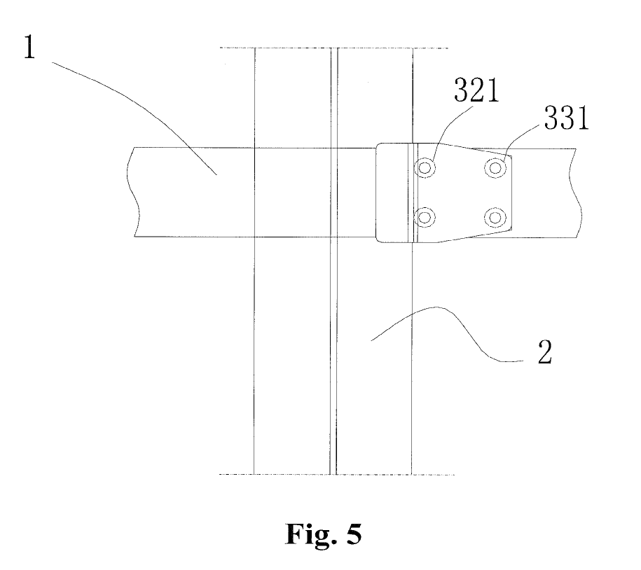

As shown in FIGS. 3, 4 and 5, the connecting plate 3 has a longitudinal section of a gooseneck shape, and comprises a wing plate coupling portion 31 for coupling to an exterior lower surface of the upper wing plate 21 of the frame main longitudinal beam 2, a fastener assembling portion 32 for connecting to one end of the wing plate coupling portion 31, a carriage bottom coupling portion 33 for coupling to a bottom surface of the carriage, and a connecting portion 34 for a slant connection between the fastener assembling portion 32 and the carriage bottom coupling portion 33. A first through holes 321 is formed passing through from top to bottom in the fastener assembling portion 32 (as indicated by the dotted line in FIG. 5), and second through holes 331 are formed passing through from top to bottom in the carriage bottom coupling portion 33 (as indicated by the dotted line in FIG. 5).

As shown in FIG. 4, the thickness and width of the connecting portion 34 are gradually decreased in the direction from the fastener assembling portion 32 to the carriage bottom coupling portion 33, such that the connecting portion 34 has an elasticity which allows the connecting portion 34 to be deformed slightly in use, so as to lower the demand on assembly accuracy.

As shown in FIG. 5, the plane outline of the connecting plate 3 may be a rectangle on one side (left side in FIG. 5) and an isosceles trapezoid on the other side (right side in FIG. 5) which extends from a longer edge of the rectangle to the other side.

In order to further strengthen the coupling stability, the side of the fastener assembling portion 32 toward the wing plate coupling portion 31 may raised to a predetermined height higher than an upper surface of the wing plate coupling portion 31 so as to form a limit boss 322.

As shown in FIG. 5, two first through holes 321 arranged transversely along the connecting plate 3 are formed in the fastener assembling portion 32; and two second through holes 331 arranged transversely along the connecting plate 3 are formed in the carriage bottom coupling portion 33. Certainly, the amount of the first through holes 321 and the second through holes 331 is not limited to two, but rather it can be adjusted based on actual requirements.

The connecting plate 3 of the invention can be forged integrally, have a structure of welded steel plates or a structure of bent steel plates.

Refer to FIGS. 3 and 4 again, the wing plate coupling portion 31 of the connecting plate 3 is coupled to an exterior lower surface of the upper wing plate 21 of the frame main longitudinal beam 2, and the carriage bottom coupling portion 33 is coupled to a bottom surface of the carriage (it is shown in the drawings coupled to a lower surface of the carriage bottom cross beams 1, but the invention does not take this as a limitation). Nuts 41 are pre-buried in positions of the carriage corresponding to the first through holes 321, and nuts 42 are pre-buried in positions of the carriage corresponding to the second through holes 331 (although it is shown in the drawings that nuts 41 and 42 are pre-buried in the carriage bottom cross beams 1, the invention is not limited thereto, that is, the nuts 41 and 42 may be pre-buried in other positions in the bottom of the carriage). Further, bolts 51 are disposed passing through the first through holes 321 as well as the nuts 41 corresponding to the first through holes 321, and bolts 52 are disposed passing through the second through holes 331 as well as the nuts 42 corresponding to the second through holes 331, thereby the wing plate coupling portion 31 can be clamped together with the upper wing plate 21 of the main longitudinal beam 2. The bolts 51 and 52 are hexagonal head bolts of high strength, and gaskets can be provided accordingly based on actual requirements.

The height difference between the upper surface of the wing plate coupling portion 31 and the upper surface of the carriage bottom coupling portion 33 is less than the thickness of the upper wing plate 21, such that the upper surface of the wing plate coupling portion 31 can be closely coupled to the exterior lower surface of the upper wing plate 21.

Although it is shown in FIGS. 3-7 that the carriage and the frame are connected together by cooperation of bolts and nuts, the invention is not limited thereto, that is, the carriage and the frame can be fastened by any means which may achieve the purpose of the invention.

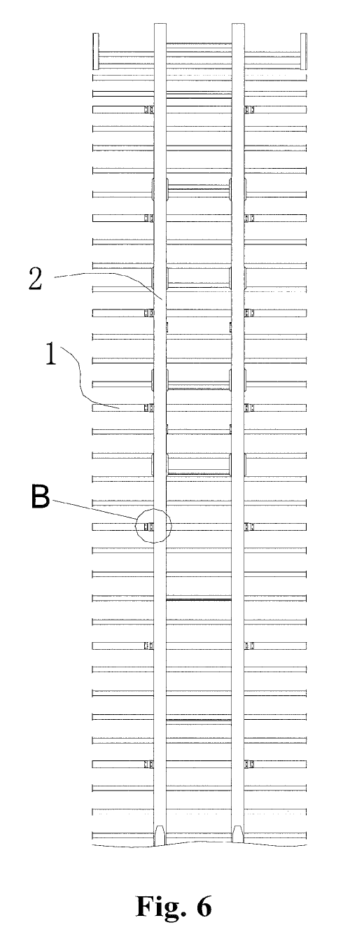

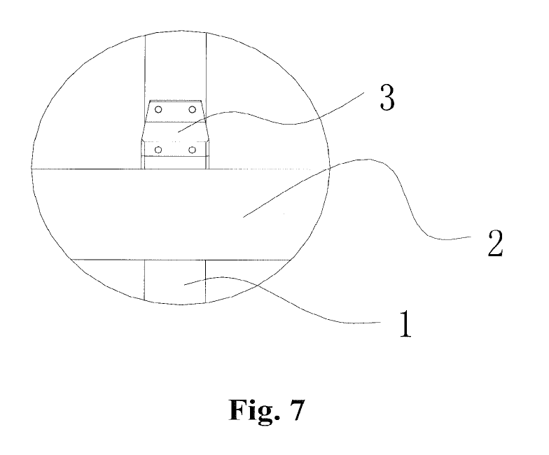

As shown in FIGS. 6 and 7, the van-type vehicle of the invention comprises seven pairs of connecting plates 3 symmetrically arranged along the longitudinal direction of the van-type vehicle. Although seven pairs of the connecting plates 3 are shown in FIGS. 6 and 7, the invention is not limited thereto, that is, at least two pairs of connecting plates 3 may be arranged.

Subsequently, the assembly of the van-type vehicle will be described briefly.

During assembling, the nuts 41 and 42 are mounted or pre-buried in the carriage or the bottom cross beams 1 firstly, and then the carriage and the frame are assembled after their production are completed respectively; the carriage is disposed on the frame to make the lower surface of the bottom cross beams 1 in contact with the upper surface of the main longitudinal beams 2, so as to determine the position of the frame relative to the carriage.

The connecting plate 3 is disposed in the position corresponding to the nuts 41 and 42, and is coupled to the lower surface of the upper wing plates of the main longitudinal beams 2 on the exterior side and the lower surface of the bottom cross beams 1, and then the bolts 51 and 52 are fastened to a prescribed torque.

In sequence, the rest connecting plates 3 are fastened to a prescribed torque by the bolts 51 and 52.

After assembling, a sufficient friction force will be produced between the surface of the lower wing plate of the main longitudinal beam 2 and the wing plate coupling portion 31, such that the connecting plate 3 arranged in pairs firmly couple the carriage and the frame together by tightly clamping the wing plate coupling portion 31 on the surface of upper wing plate 21 of the main longitudinal beam 2 on the exterior side. Additionally, the limit boss 322 can further limit the movement of the upper wing plate 21 of the main longitudinal beam 2 in relative to the bottom cross beam 1.

The van-type vehicle of the invention can be achieved by respectively manufacturing the carriage and the frame in flow-line production, and then assembling them together. So the van-type vehicle of the invention has a simple structure, a greater strength, and an easy production, having a great value in use.

The above mentioned contents are only the preferable embodiments of the invention. The embodiments are not intended to limit the protection scope of the invention, that is, any equivalent structural alternation made in accordance to the description and drawings of the invention shall be in the protection scope of the invention.

1. A connecting plate for connecting a carriage and a frame of a van-type vehicle, wherein the connecting plate has a longitudinal section of a gooseneck shape and comprises a wing plate coupling portion for coupling to a lower surface of an upper wing plate of a frame main longitudinal beam on exterior side, a fastener assembling portion for connecting to one end of the wing plate coupling portion, a carriage bottom coupling portion for coupling to a bottom surface of the carriage, and a connecting portion for a slant connection between the fastener assembling portion and the carriage bottom coupling portion; first through holes are formed passing through from top to bottom in the fastener assembling portion; second through holes are formed passing through from top to bottom in the carriage bottom coupling portion; a height difference between an upper surface of the wing plate coupling portion and the carriage bottom coupling portion is less than a thickness of the upper wing plate; and a thickness and a width of the connecting portion are gradually decreased from the fastener assembling portion to the carriage bottom coupling portion.

2. The connecting plate according to claim 1, wherein a limit boss is formed between a side surface of the fastener assembling portion facing the wing plate coupling portion and the upper surface of the wing plate coupling portion.

3. The connecting plate according to claim 1, wherein two first through holes arranged transversely along the connecting plate are formed in the fastener assembling portion; and two second through holes arranged transversely along the connecting plate are formed in the carriage bottom coupling portion.

4. The connecting plate according to claim 1, wherein the connecting plate is forged integrally, or has a structure of welded steel plates or a structure of bent steel plates.

5. The connecting plate according to claim 1, wherein a plane outline of the connecting plate is a rectangle on one side and an isosceles trapezoid on the other side which extends from a longer edge of the rectangle to the other side.

6. A van-type vehicle comprising a carriage and a frame, a plurality of bottom cross beams being disposed in the bottom of the carriage, and the frame comprises at least two main longitudinal beams, wherein the van-type vehicle further comprises at least two pairs of connecting plates symmetrically disposed along a longitudinal direction of the van-type vehicle according to claim 1; the wing plate coupling portion of the connecting plate is coupled to the lower surface of the upper wing plate of the frame longitudinal beam on exterior side; the carriage bottom coupling portion is coupled to the bottom surface of the carriage; nuts are pre-buried in the positions of the carriage corresponding to the first through holes and the second through holes of the connecting plate; bolts are disposed passing through the first through holes as well as the nuts corresponding to the first through holes, and bolts are disposed passing through the second through holes as well as the nuts corresponding to the second through holes.

7. The van-type vehicle according to claim 6, wherein the nuts are pre-buried in the bottom cross beams of the carriage, and the carriage bottom coupling portion of the connecting plate is coupled to the lower surface of the bottom cross beam.

8. The van-type vehicle according to claim 6, wherein the van-type vehicle comprises seven pairs of connecting plates.

9. The van-type vehicle according to claim 6, wherein a limit boss is formed between a side surface of the fastener assembling portion facing the wing plate coupling portion and the upper surface of the wing plate coupling portion.

10. The van-type vehicle according to claim 6, wherein two first through holes arranged transversely along the connecting plate are formed in the fastener assembling portion; and two second through holes arranged transversely along the connecting plate are formed in the carriage bottom coupling portion.

11. The van-type vehicle according to claim 6, wherein the connecting plate is forged integrally, or has a structure of welded steel plates or a structure of bent steel plates.
